(19) United States
(12) Patent Application Publication
(10) Pub. No.: US 2023/0401538 A1
(43) Pub. Date: Dec. 14, 2023

(54) METHODS AND SYSTEMS FOR OPTIMIZING APPOINTMENT SCHEDULING

(71) Applicant: CDK GLOBAL, LLC, Hoffman Estates, IL (US)

(72) Inventors: Priya Saha, Fremont, CA (US); Joachim Hubele, San Marcos, TX (US)

(21) Appl. No.: 17/805,928

(22) Filed: Jun. 8, 2022

(51) Int. Cl. G06Q 10/10

(52) U.S. Cl. CPC G06Q 10/1095

(57) ABSTRACT

Examples described herein include methods, techniques, and systems for optimizing appointment scheduling of an establishment. The establishment may be part of any industry that provides goods and/or services to a plurality of persons. To optimize appointment scheduling, the methods, techniques, and systems described herein may analyze appointment data of a past time period to predict whether the persons will keep their respective pre-scheduled appointments in a future time period. To do so, the establishment may utilize a two-tier predictive module to perform a first predictive categorization followed by a second predictive categorization. The first predictive categorization may aid the establishment to determine whether the pre-scheduled appointments for the future time period are predicted to be kept appointments or missed appointments. Then, the second predictive categorization may aid the establishment to determine whether the predicted kept appointments are predicted to be on-time appointments or delayed appointments.

### BACKGROUND

Automotive, air travel, medical, hospitality, and/or other industries may offer goods and/or services to people (customers, clients, patients, etc.) on a walk-in demand (e.g., walk-in appointment) and/or a pre-scheduled demand (e.g., pre-scheduled appointment) basis. These industries often encourage, prefer, and/or require people to pre-schedule an appointment with an establishment associated with these industries. Depending on the industry, the establishment may be an automotive dealership, a mechanic shop, a medical facility, a veterinarian facility, a restaurant, a hotel, an airline, a travel agency, a barber shop, a spa, a beauty salon, or any establishment that offers goods and/or services to customers, clients, patients, and the like.

The pre-scheduled appointments may help the establishment with proper staffing, inventory, equipment, space, and other aspects of the goods and/or services provided by the establishment. Unfortunately, people often miss these scheduled appointments, leading to significant business losses. Depending on the industry, the establishment may put in place a variety of penalties for the missed appointments in order to discourage missed or delayed appointments. For example, an airline may sell non-refundable tickets or may charge a relatively high fee to cancel a flight or change the flight. As another example, a medical clinic may require 24-hour notice to cancel a visit or reschedule the visit. Nevertheless, some industries do not practice such measures to cancel or delay a pre-scheduled appointment. To this end, many establishments may practice over-booking (sometimes referred to as “blind over-booking”), in an attempt to counterbalance (or cancel out) the missed and/or delayed appointments. However, improper estimation(s) of walk-in appointments, missed appointments, delayed appointments, and/or over-booked appointments may result in operational inefficiency.

For example, in a case of an automotive dealership (e.g., car dealership, vehicle dealership), improper estimation of the walk-in appointments, the missed appointments, the delayed appointments, and/or the over-booked appointments may cause issues, such as a lack of shop capacity, collisions of customers' appointments, increased wait time, technician or mechanic unavailability, salesperson unavailability, a shortage of parts, a shortage of vehicles, and more. Therefore, over-booking may increase customer dissatisfaction, which can adversely impact a vehicle-service business-side and/or a vehicle-sales business-side of the automotive dealership. On the other hand, automotive dealerships that do not practice over-booking may suffer from reduced revenue generation due to underutilized and/or empty appointment slots.

### BRIEF DESCRIPTION OF THE SEVERAL VIEWS OF THE DRAWINGS

FIG. 1 illustrates an environment of a person scheduling an appointment with an establishment in accordance with examples described herein.

FIG. 2 illustrates an environment of a first plurality of appointment data of a first plurality of persons, and the first plurality of appointment data are associated with a past time period in accordance with examples described herein.

FIG. 3 illustrates an environment of a second plurality of appointment data of a second plurality of persons, and the second plurality of appointment data are associated with a future time period in accordance with examples described herein.

FIG. 4 illustrates an environment of an example computing device accessing the first plurality of appointment data and the second plurality of appointment data stored in a database in accordance with examples described herein.

FIG. 5 illustrates an environment of a prediction module, the prediction module includes a cancelation predictor and a delay predictor in accordance with examples described herein.

### DETAILED DESCRIPTION

Examples described herein include methods, techniques, and systems for optimizing appointment scheduling of an establishment. The establishment may be part of any industry that provides goods and/or services to a plurality of persons on a pre-scheduled basis and/or a walk-in basis. Depending on the type of the establishment, the person may be a client, a customer, a patient, an owner (e.g., an owner of a vehicle, an owner of a pet), a caretaker (e.g., a parent or a guardian of a child, a child of an elderly parent), and so forth.

To optimize appointment scheduling, the methods, techniques, and systems described herein may analyze appointment data of a past time period to predict whether the persons will keep their respective pre-scheduled appointments in a future time period. To do so, the establishment may utilize a two-tier predictive module (e.g., software module(s)) to perform a first predictive categorization followed by a second predictive categorization. The first predictive categorization may aid the establishment determine whether the pre-scheduled appointments for the future time period are predicted to be kept appointments or missed appointments. Then, the second predictive categorization may aid the establishment determine whether the predicted kept appointments are predicted to be on-time appointments or delayed appointments.

In one aspect, a computer-implemented method for aiding an establishment in scheduling future appointments includes accessing a first plurality of appointment data of a first plurality of persons, the first plurality of appointment data being associated with a plurality of scheduled appointments over a past time period. The computer-implemented method also includes accessing a second plurality of appointment data of a second plurality of persons, the second plurality of appointment data being associated with a plurality of pre-scheduled appointments for a future time period. The computer-implemented method also includes, based on the first plurality of appointment data and the second plurality of appointment data, performing a first predictive categorization of the plurality of pre-scheduled appointments for the future time period, where a first portion of the plurality of pre-scheduled appointments includes a plurality of predicted kept appointments in the future time period, and a second portion of the plurality of pre-scheduled appointments include a plurality of predicted missed appointments in the future time period. Then, the computer-implemented method may also include performing a second predictive categorization of the plurality of pre-scheduled appointments for the future time period, where a first portion of the plurality of predicted kept appointments includes a plurality of predicted on-time appointments in the future time period, and a second portion of the predicted kept appointments includes a plurality of predicted delayed appointments in the future time period. By so doing, an establishment can increase their operational efficiency in the future time period.

In another aspect, a system for scheduling appointments includes a database. The database may include a first plurality of appointment data associated with a plurality of scheduled appointments over a past time period. The database may also include a second plurality of appointment data associated with a plurality of pre-scheduled appointments for a future time period. The system also includes a computing device. The computing device may include a network interface, a processor, and a computer-readable medium. The computer-readable medium includes instructions that, when executed by the processor, configure the computing device to communicate with the database using the network interface. By so doing, the computing device can access the first plurality of appointment data and the second plurality of appointment data from the database. The system may utilize a cancelation predictor to determine a plurality of predicted kept appointments in the future time period, and a plurality of predicted missed appointments in the future time period. The system may also utilize a delay predictor to determine a plurality of predicted on-time appointments in the future time period, and a plurality of predicted delayed appointments in the future time period.

In yet another aspect, a non-transitory computer-readable storage medium may include instructions that when executed by a processor, cause the processor to access a first plurality of appointment data from a database, where the first plurality of appointment data include a plurality of scheduled appointments over a past time period. The instructions may also cause the processor to access a second plurality of appointment data from the database, where the second plurality of appointment include a plurality of pre-scheduled appointments for a future time period. Based on the first plurality of appointment data and the second plurality of appointment data, the instructions may also cause the processor to perform a first predictive categorization of the plurality of pre-scheduled appointments for the future time period, where a first portion of the plurality of pre-scheduled appointments includes a plurality of predicted kept appointments in the future time period, and a second portion of the plurality of pre-scheduled appointments comprise a plurality of predicted missed appointments in the future time period. The instructions may also cause the processor to perform a second predictive categorization of the plurality of predicted kept appointments, where a first portion of the plurality of predicted kept appointments includes a plurality of predicted on-time appointments in the future time period, and a second portion of the predicted kept appointments comprises a plurality of predicted delayed appointments in the future time period.

The disclosure partly focuses on the establishment being a vehicle dealership, partly because dealerships offer goods and/or services on a pre-schedule basis and walk-in basis. Furthermore, it is not customary for dealerships to hold people accountable for missed appointments by charging cancelation or re-scheduling fees. Therefore, optimizing appointment scheduling for dealerships may be challenging using conventional methods, techniques, and systems. It is to be appreciated that the methods, techniques, and systems described herein overcome many challenges of the conventional methods, techniques, and systems. It is to be understood, however, that the methods, techniques, and systems described herein may be used by other establishments and/or industries.

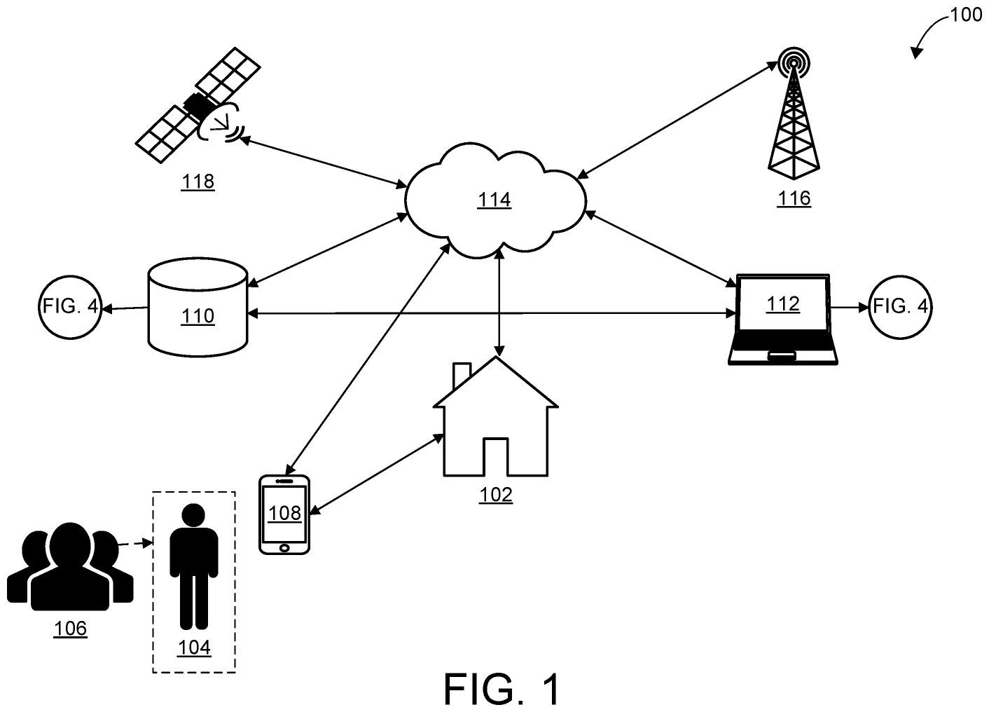

FIG. 1 illustrates an environment 100 of an establishment 102 in accordance with examples described herein. The establishment 102 may be an automotive dealership, a mechanic shop, a medical facility, a veterinarian facility, a restaurant, a hotel, an airline, a travel agency, a barber shop, a spa, a beauty salon, or any establishment that offers goods and/or services to a person 104 and/or persons 106. Depending on the type of the establishment 102, the person 104 may be a client, a customer, a patient, an owner (e.g., an owner of a vehicle, an owner of a pet), a caretaker (e.g., a parent or a guardian of a child, a child of an elderly parent), and the like. For clarity and brevity, FIG. 1 illustrates and/or describes the person 104 in detail. It is to be understood, however, that the person 104 is part of a plurality of persons 106 who use goods and/or services offered by the establishment 102. Note that FIG. 1 and any figure in this disclosure may not be drawn to scale.

In some embodiments, the person 104 (and/or the persons 106) may use the goods and/or services by arriving (e.g., a walk-in appointment) at the establishment 102 or may schedule an appointment (e.g., a pre-scheduled appointment) in advance with the establishment 102 for a particular appointment slot (e.g., 8:00 AM, 10:00 AM, 10:30 AM, 4:00 PM, and the like of a particular date) during a future time period (e.g., within the next 24 hours, within the next week, within the next month, within the next six months, within the next year, and so forth). To schedule (or book) an appointment, the person 104 may arrive at the establishment 102 and may communicate with personnel of, or associated with, the establishment 102. Alternatively, or additionally, the person 104 may utilize a user device 108 to communicate with the establishment 102, a communication device (not illustrated) inside the establishment 102, and/or the personnel associated with the establishment 102. For example, using the user device 108, the person 104 may use an application software (e.g., a web-based application software) to schedule an appointment with the establishment 102. As another example, using the user device 108, the person 104 may call (e.g., using telephony) the personnel (e.g., a receptionist) working at the establishment 102 to schedule an appointment. As another example, using the user device 108, the person 104 may text a phone number associated with the establishment 102 to schedule an appointment. As yet another example, using the user device 108, the person 104 may email an email address associated with the establishment 102 to schedule an appointment. The user device 108 may be any computing device, such as a phone, a smartphone, a desktop computer, a laptop computer, a notebook, a wearable device, and/or other examples of computing devices that enable the person 104 to communicate with the establishment 102.

In some embodiments, the establishment 102 may utilize a database(s) 110 to store a first plurality of appointment data of a first plurality of persons, where the first plurality of appointment data may be appointment data over a past time period, such as during the past 24 hours, the past week, the past month, the past six months, the past year, and so forth. Additionally, or alternatively, the establishment 102 may utilize the database(s) 110 to store a second plurality of appointment data of a second plurality of persons, and the second plurality of appointment data may be associated with scheduled (e.g., pre-scheduled) appointment data for a future time period, such as for the next 24 hours, the next week, the next month, the next six months, the next year, and so forth. The first plurality of persons may be different, partly different, or the same as the second plurality of persons. For example, for repeat customers from the past time period to the future time period, a person of the first plurality of persons may be the same person of the second plurality of persons.

In some embodiments, the establishment 102 may also utilize a computing device 112 that may analyze the data stored in the database(s) 110. For example, the computing device 112 may analyze the first plurality of appointment data to make a prediction regarding the second plurality of appointment data. By so doing and/or by better-predicting the second plurality of appointment data, the establishment 102 may determine a count of over-booked appointment(s), may determine a count of under-booked appointment(s), may determine a count of optimally-booked appointment(s), may increase the operational efficiency of the establishment 102, may increase customer satisfaction, may increase customer loyalty, may increase employee job satisfaction, may increase a revenue of the establishment 102, may increase a profit of the establishment 102, may better manage an inventory of the establishment 102, and the like.

FIG. 1 illustrates the establishment 102, the database(s) 110, and the computing device 112 as distinct (or separate) entities. Nevertheless, the database(s) 110 and the computing device 112 may be integrated. Furthermore, the database(s) 110 and/or the computing device 112 may be inside the establishment 102 (e.g., inside a building of a dealership) or may be on a server outside the establishment 102.

In some embodiments, the various devices and/or entities in the environment 100 may communicate with each other directly and/or via a network 114. The network 114 may facilitate communication between the establishment 102, the user device 108, the database(s) 110, the computing device 112, a base station(s) 116, a satellite(s) 118, and/or other components that may not be explicitly illustrated in FIG. 1. Communication(s) in the environment 100 of FIG. 1 may be performed using various protocols and/or standards. Examples of such protocols and standards include: a 3rd Generation Partnership Project (3GPP) Long-Term Evolution (LTE) standard, such as a 4th Generation (4G) or a 5th Generation (5G) cellular standard; an Institute of Electrical and Electronics (IEEE) 802.11 standard, such as IEEE 802.11g, ac, ax, ad, aj, or ay (e.g., Wi-Fi 6® or WiGig®); an IEEE 802.16 standard (e.g., WiMAX®); a Bluetooth Classic® standard; a Bluetooth Low Energy® or BLE® standard; an IEEE 802.15.4 standard (e.g., Thread® or ZigBee®); other protocols and/or standards that may be established and/or maintained by various governmental, industry, and/or academia consortiums, organizations, and/or agencies; and so forth. Therefore, the network 114 may be a cellular network, the Internet, a wide area network (WAN), a local area network (LAN), a wireless LAN (WLAN), a wireless personal-area-network (WPAN), a mesh network, a wireless wide area network (WWAN), a peer-to-peer (P2P) network, and/or a Global Navigation Satellite System (GNSS) (e.g., Global Positioning System (GPS), Galileo, Quasi-Zenith Satellite System (QZSS), BeiDou, GLObal NAvigation Satellite System (GLONASS), Indian Regional Navigation Satellite System (IRNSS), and so forth).

In addition to, or alternatively of, the communications illustrated in FIG. 1, the environment 100 may facilitate other unidirectional, bidirectional, wired, wireless, direct, and/or indirect communications utilizing one or more communication protocols and/or standards. Therefore, FIG. 1 does not necessarily illustrate all communication signals.

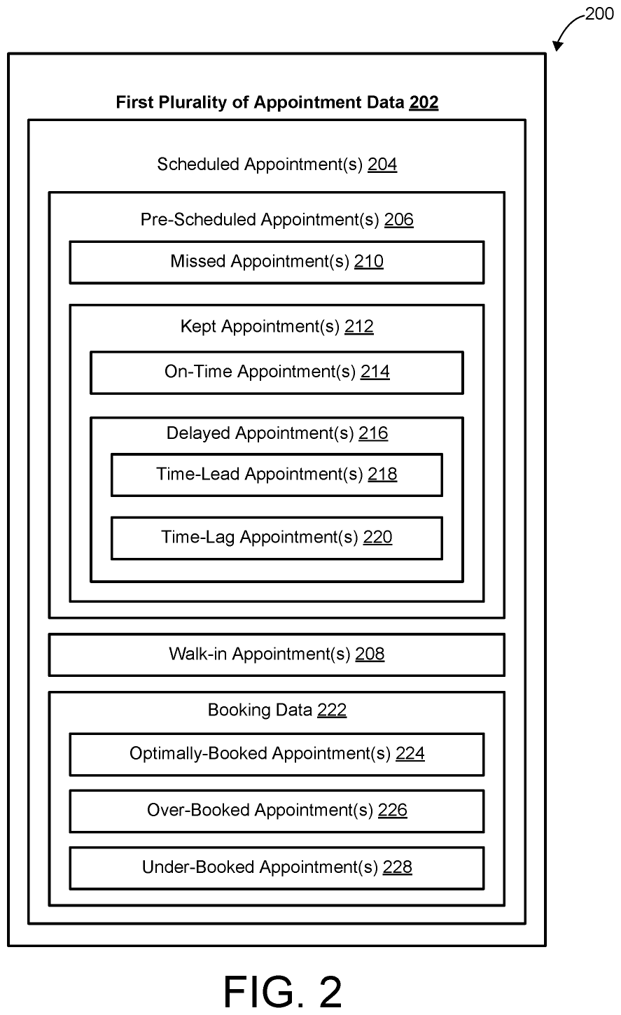

FIG. 2 illustrates an environment 200 of a first plurality of appointment data 202 of a first plurality of persons, and the first plurality of appointment data 202 are associated with a past time period in accordance with examples described herein. The past time period may be defined by the establishment 102 and may include the past 24 hours, the past week, the past month, the past fiscal quarter, the past six months, the past year, the past fiscal year, or any past time period. Note that FIG. 2 is partly described in the context of FIG. 1. For example, the first plurality of appointment data 202 may be stored in the database(s) 110 of FIG. 1.

In some embodiments, the first plurality of appointment data 202 may include scheduled appointment(s) 204 over the past time period. As described herein, the scheduled appointment(s) 204 may be any appointment requested by the persons (e.g., the first plurality of persons) during the past time period. The scheduled appointment(s) 204 may include pre-scheduled appointment(s) 206 and/or walk-in appointment(s) 208. For clarity, a count (or percentage) of the pre-scheduled appointment(s) 206 plus a count (or percentage) of the walk-in appointment(s) 208 may equal the total count (or 100%) of the scheduled appointment(s) 204 during the past time period.

In some embodiments, the scheduled appointment(s) 204 may include only (or mainly) the pre-scheduled appointment(s) 206. For example, a highly-specialized plastic surgeon may only accept and/or operate on patients on a pre-schedule basis, sometimes months in advance. Therefore, the highly-specialized plastic surgeon may not operate on patients on a walk-in basis. In some embodiments, the scheduled appointment(s) 204 may include a considerably-greater count (or percentage) of the pre-scheduled appointment(s) 206 and a considerably lesser count (or percentage) of the walk-in appointment(s) 208. For example, an airline may fill (or sell) most of the airplane seats on a pre-schedule basis, but the airline may also fill some of the airplane seats on a walk-in basis (e.g., a passenger purchasing a ticket in a retail kiosk of an airport, a passenger purchasing a ticket on the day of the flight). In some embodiments, the scheduled appointment(s) 204 may include a sizeable count (or percentage) of pre-scheduled appointment(s) 206 and a sizeable count of walk-in appointment(s) 208. For example, a dealership may service vehicles (e.g., repair vehicles, perform regular maintenance on vehicles) or may sell vehicles on a pre-schedule basis and/or a walk-in (e.g., drive-in) basis.

Unfortunately, in the past time period, some people may have not kept the pre-scheduled appointment(s) 206 that they scheduled with the establishment 102. Therefore, the pre-scheduled appointment(s) 206 may include missed appointment(s) 210 and/or kept appointment(s) 212. For clarity, a count (or percentage) of the missed appointment(s) 210 plus a count (or percentage) of the kept appointment(s) 212 may equal the total count (or 100%) of the pre-scheduled appointment(s) 206 during the past time period. Note that in FIG. 2, the kept appointment(s) 212 are not illustrated as being part of the walk-in appointment(s) 208, even though the walk-in appointment(s) 208 are inherently kept appointments. For example, a person may drive to the dealership (e.g., the establishment 102 of FIG. 1) and may wait in the lobby of the dealership until the personnel of the dealership may be able to attend to their needs (e.g., accept their vehicle to be repaired). Nevertheless, the establishment 102 may prefer to accommodate pre-scheduled appointment(s) 206, since the pre-scheduled appointment(s) 206 help the establishment 102 to better predict the staffing needs (e.g., technicians), inventory (e.g., vehicles parts), shop space, and other factors that may affect operational efficiency, revenue, profits, customer satisfaction, employee satisfaction, and so forth.

In some embodiments, a missed appointment(s) 210 may be an appointment that a person (e.g., the person 104 and/or the persons 106 of FIG. 1) may have not kept at all. For example, a person may desire to fix their vehicle at a dealership (e.g., the establishment 102), and the person may have scheduled to drop their car at the dealership at a certain time or a certain time slot (e.g., at 10:30 AM of a certain date) during the past time period. However, the first plurality of appointment data 202 that may be stored in the database(s) 110 may show that the person did not drop their vehicle(s) at all at the dealership. In such a scenario, the dealership may be overstaffed and/or under-booked for the time slot (e.g., the 10:30 AM time slot). Furthermore, even though a person may have kept the pre-scheduled appointment, the establishment 102 may prefer that the person be on time, instead of on a delayed time (e.g., before or after the 10:30 AM time slot). Therefore, the kept appointment(s) 212 may include on-time appointment(s) 214 and/or delayed appointment(s) 216. For clarity, a count (or percentage) of the on-time appointment(s) 214 plus a count (or percentage) of the delayed appointment(s) 216 may equal the total count (or 100%) of the kept appointment(s) 212.

In some embodiments, the establishment 102 (e.g., personnel working in, and/or associated with, the establishment 102) may define an on-time appointment 214 as a person arriving at the appointment within a predetermined time frame (or predetermined time window) of the pre-scheduled appointment 206. The predetermined time window, however, may change depending on the type of the establishment. In some embodiments, the predetermined time window may only include a predetermined time period before the scheduled appointment. For example, an airline may not accept passengers that arrive at a gate of an airport after the boarding of the plane has completed, regardless of the fact that the plane may still be on the tarmac (e.g., airport apron, flight line, ramp). In some embodiments, the predetermined time window may include a predetermined time period before the scheduled appointment and a predetermined time period after the scheduled appointment. For example, a dealership may consider a person arriving for a scheduled appointment (e.g., the pre-scheduled appointment 206 of FIG. 2) up to minutes before the scheduled appointment, on time for the scheduled appointment, or up to minutes later from the scheduled appointment, as being an on-time appointment (e.g., the on-time appointment(s) 214). For example, if a person is scheduled to arrive at a dealership (e.g., the establishment 102 of FIG. 1) at 10:30 AM of a particular date, the establishment 102 may consider the person's arrival between 10:15 AM to 10:45 AM as being an on-time appointment(s) 214. In this example, the predetermined time window is 30 minutes. Furthermore, the establishment 102 may adjust the predetermined time window.

In some embodiments, a delayed appointment(s) 216 may be a time-lead appointment(s) 218 or a time-lag appointment(s) 220. In one aspect, the time-lead appointment(s) 218 may be denoted as a positive delayed appointment(s) 216, and the time-lag appointment(s) 220 may be denoted as a negative delayed appointment(s) 216. In another aspect, the time-lead appointment(s) 218 may denote a person arriving before the scheduled appointment (e.g., arriving at 9:30 AM instead of 10:30 AM), and the time-lag appointment(s) 220 may denote a person arriving after the scheduled appointment (e.g., arriving at 11:30 AM instead of 10:30 AM).

In some embodiments, the first plurality of appointment data 202, the scheduled appointment(s) 204, the pre-scheduled appointment(s) 206, and the walk-in appointment(s) 208 help the establishment 102 to analyze booking data 222. The establishment 102 may analyze the booking data 222 in aggregate (e.g., the whole past time period), over a certain time period of the past time period (e.g., day-by-day over the past time period), over a time slot of the past time period, and/or a combination thereof. Over the past time period, analysis of the booking data 222 may show optimally-booked appointment(s) 224, over-booked appointment(s) 226, or under-booked appointment(s) 228. Obviously, it behooves the establishment 102 to have optimally-booked appointment(s) 224.

Although not explicitly illustrated in FIG. 2, the first plurality of appointment data 202 may include additional information, partly depending on the establishment 102. For example, in some embodiments, the establishment 102 may be an airline, a travel agency (e.g., in-person travel agency, a web-based travel agency) utilizing the airline, a retail kiosk associated with the airline, a travel search engine, and/or so forth. In such a case, the first plurality of appointment data 202 may also include demographic information (e.g., statistical metadata of the passengers), timing (e.g., hour of the day, day of the week, week of the month, month of the year), flight number(s), airport name(s), weather information, fuel costs, airfare prices, gross domestic product (GDP) or per-capita GDP information (e.g., a higher GDP may correlate to higher air travel), unemployment rates (e.g., a lower unemployment rate may correlate to higher air travel), geopolitical events that may have affected travel during the past time period (e.g., restrictions on international travel), competition (e.g., from other airlines and/or other modes of transportation), and/or other factors that may have affected air travel during the past time period.

In some embodiments, the establishment 102 may be a dealership, and the dealership may include a vehicle-service business-side and/or a vehicle-sales business-side, and both business sides may affect the success (e.g., profits) of the dealership. Furthermore, a performance of the vehicle-service business-side of the dealership may have an effect on the vehicle-sales business-side of the dealership. For example, a poor performance in the vehicle-sales business-side may result in fewer customers arriving at the dealership. In such a scenario, the dealership may have fewer opportunities to sell vehicles (e.g., new and/or used vehicles).

In some embodiments, in addition to, or alternatively of, what is explicitly illustrated in FIG. 2, the first plurality of appointment data 202 may also include repair-order (RO) data that the dealership (e.g., the establishment 102 of FIG. 2) may have generated prior to the customer (e.g., the person 104 of FIG. 1) arriving at the dealership and/or after the customer arriving at the dealership. For example, in the past time period, a customer may have scheduled an appointment (e.g., a pre-scheduled appointment 206 or a walk-in appointment 208) with the dealership (e.g., the establishment 102 of FIG. 2) to perform a specific task(s) or an operation(s) (e.g., an oil change, an alignment, and so forth) to the vehicle of the customer. In such a case, the first plurality of appointment data 202 may include the RO data of said specific task(s) or operation(s). As another example, the customer may have scheduled an appointment to repair their vehicle, but the customer may have not known in advance what repairs were needed to be completed on their vehicle. In such a case, in the past time period, personnel of the dealership may have diagnosed the vehicle after the customer brought (e.g., drove, towed) the vehicle to the dealership, and the personnel (e.g., technicians) of the dealership may have generated a list of operations (e.g., RO data) to be performed to and/or on the vehicle. In such a case, the first plurality of appointment data 202 may include the list of operations (e.g., the RO data).

In some embodiments, the availability of an RO record (or RO data) of a vehicle at the dealership may confirm that the customer visited the dealership during the past time period. On the other hand, an unavailability of an RO record may indicate that the customer missed the appointment. Although, the dealership may generate RO records for walk-in appointment(s) 208 and the pre-scheduled appointment(s) 206, to determine a count (or percentage) of the missed appointment(s) 210 during the past time period, the dealership may filter out the RO records associated with the walk-in appointment(s) 208. Then, the dealership may compare the pre-scheduled appointment(s) 206 to the RO records during the past time period. In such a case, the kept appointment(s) 212 have an RO record, and the missed appointment(s) 210 do not have an RO record.

In some embodiments, the dealership (e.g., the establishment 102 of FIG. 2), by using the computing device 112 of FIG. 1, may analyze the RO records of the first plurality of appointment data 202 that may be stored in the database(s) 110. The analysis may reveal that a considerable count of the RO records shows a time lag (e.g., a time-lag appointment(s) 220) compared to the pre-scheduled appointment(s) 206. In such a case, the time-lag appointment(s) 220 may not be due to the customer being late for the pre-scheduled appointment(s) 206, but the dealership may have been over-booked (e.g., over-booked appointment(s) 226) for the time slot. Consequently, the personnel of the dealership did not start diagnosing the vehicle of the customer on a timely manner. For example, if the time lag between the RO record and the pre-scheduled appointment(s) 206 is between zero (0) to 24 hours, it may be possible that the customer arrived on time, but the dealership may have been over-booked and did not start diagnosing the vehicle on a timely manner, such as shortly after the arrival of the vehicle. As another example, if the time lag between the RO record and the pre-scheduled appointment(s) 206 is greater than 24 hours, it may be possible that the customer arrived later than the pre-scheduled appointment(s) 206. Therefore, analyzing the first plurality of appointment data 202 may help the establishment 102 understand the behavior of the persons 106 and the operational efficiency of the establishment 102 during the past time period.

In some embodiments, the dealership may not rely in the RO records, but may track an arrival time of the customers and compare the arrival time to the pre-scheduled appointment 206. Therefore, the dealership, using the computing device 112 may analyze the behavior of the customers during the past time period by filtering out the cases when the dealership may have not generated the RO record shortly after the arrival of the vehicle. A lack of penalty from the dealership for a missed appointment(s) 210 may result in revenue loss. Furthermore, although the dealership may favor a delayed appointment(s) 216 over a missed appointment(s) 210, unfortunately, delayed appointment(s) 216 may result in an operational inefficiency of the dealership. Therefore, the delayed appointment(s) 216 may also result in revenue loss for the dealership.

In some embodiments, the first plurality of appointment data 202 may include geographic data of “sister” dealerships, such as dealerships that specialize in repairing and selling vehicles from a particular original equipment manufacturer (OEM). For example, in the United States of America, the geographic data may include the city and state of the persons 106 (e.g., based on the addresses of the persons 106) and the city and state of the dealerships. The dealerships may share the geographic metadata of the first plurality of appointment data 202 by, for example, removing the identities of the persons 106. Then, each, some, or all sister dealerships may utilize the computing device 112 to perform a statistical analysis (e.g., the Mann-Whitney U Test) of the geographic metadata to determine, group, and/or categorize dealerships with relatively high numbers of delayed appointment(s) 216 and dealerships with relatively low numbers of delayed appointment(s) 216. In some embodiments, the dealerships with relatively high numbers of delayed appointment(s) 216 may have relatively high numbers of time-lead appointment(s) 218. In such cases, the persons 106 may have purposely arrived earlier than the pre-scheduled appointment(s) 206, partly due to the longer waiting times they may have experienced during previous visits. Furthermore, the statistical analysis of the first plurality of appointment data 202, may also reveal the most common amount of time (e.g., four hours) of the time-lead appointment(s) 218.

Although not illustrated in FIG. 2, in some embodiments, the first plurality of appointment data 202 may also include a value of a days-out of the pre-scheduled appointment(s) 206. For example, when a customer pre-schedules a next-day appointment, they are more likely to be keep the appointment and/or be on time for the appointment than when the customer pre-schedules an appointment several days in advance (e.g., 10 days in advance). Therefore, customers that pre-schedule an appointment slot within a shorter time period of the appointment slot may be more likely to keep the appointment (e.g., kept appointment(s) 212) and/or be on time for the appointment (e.g., on-time appointment(s) 214) than customers that pre-schedule an appointment slot outside the shorter time period (e.g., 10 days in advance).

Continuing with the example of the establishment 102 being a dealership, the first plurality of appointment data 202 may include additional data, such as whether a person 104 opted to receive messages, reminders, and/or notifications (e.g., emails, text messages, phone calls, appointment reminders) from the dealership; the mileage of the vehicle; the year the vehicle was manufactured; whether the vehicle is under warranty; and/or other data that may correlate with any of the appointment categories illustrated in FIG. 2. For example, a person who owns a vehicle under a warranty may be more likely to keep an appointment and/or be on time for the appointment than another person who may have not purchased a vehicle warranty. As another example, a person who owns a newer vehicle may be more likely to keep the appointment and/or be on time for the appointment than another person who owns an older vehicle. As yet another example, a person who can receive messages, reminders, and/or notifications from the dealership may be more likely to keep the appointment and/or be on time for the appointment than another person who cannot receive messages, reminders, and/or notifications from the dealership.

In addition to, or alternatively of, the scheduled appointment(s) 204 and/or the other categories and/or sub-categories that are illustrated in FIG. 2, in the past time period, the first plurality of appointment data 202 may have included other categories and/or sub-categories of scheduled appointments, such as: complete appointments, no-show appointments, canceled appointments, working appointments, and paused appointments. In such a scenario, the complete appointments, the working appointments, the paused appointments, or a combination thereof indicate that these appointments are kept appointments (e.g., similar to the kept appointment(s) 212 of FIG. 2), and the vehicles of these appointments are serviced or are in the process of being serviced. Whereas, the no-show appointments, the canceled appointments, or a combination thereof indicate these appointments are missed appointments (e.g., similar to the missed appointment(s) 210 of FIG. 2).

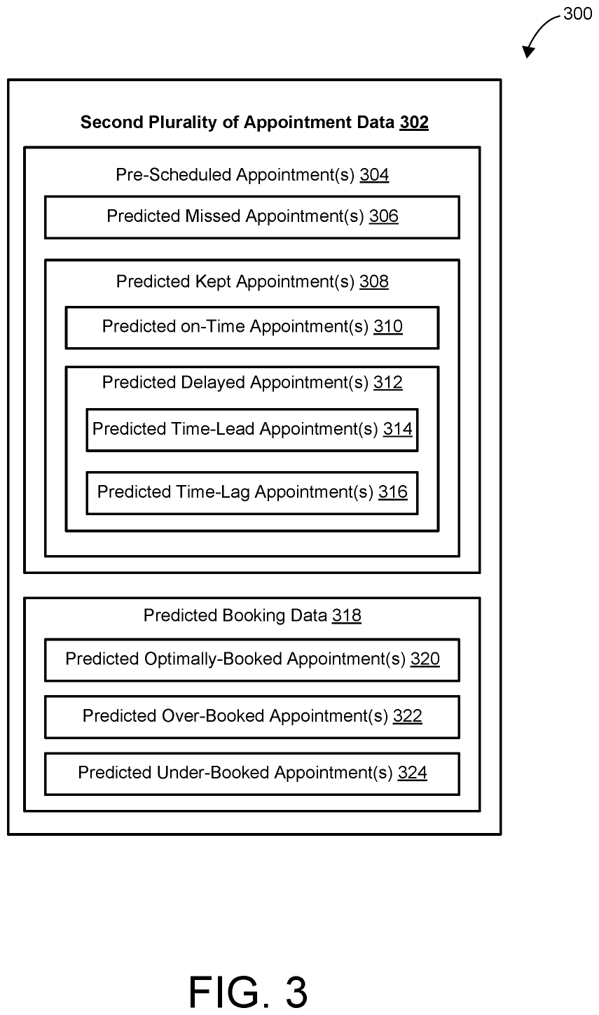

FIG. 3 illustrates an environment 300 of a second plurality of appointment data 302 of a second plurality of persons, and the second plurality of appointment data 302 are associated with a future time period in accordance with examples described herein. The future time period may be defined by the establishment 102 and may include the next 24 hours, the next week, the next month, the next fiscal quarter, the next six months, the next year, the next fiscal year, or any future time period. Note that FIG. 3 is described in the context of FIGS. 1 and 2. For example, the second plurality of appointment data 302 may also be stored in the database(s) 110 of FIG. 1.

Since like items in FIG. 2 may be the same as, similar to, and/or equivalent to with like items in FIG. 3, for the sake of brevity, FIG. 3 may not be described as in detail as FIG. 2. It is to be understood, however, that most of the description of FIG. 2 may be applied to describe FIG. 3, with a few notable exceptions, such as the description of FIG. 2 focuses on the past time period, whereas the description of FIG. 3 focuses on the future time period. As such, FIG. 3 and the accompanying description may include some known data and some predicted data, and the predicted data of FIG. 3 is partly based on the first plurality of appointment data 202 of FIG. 2 (historical data) and a second plurality of appointment data 302 of FIG. 3 (partly statistical data). For clarity, an illustration(s) and/or a description(s) of:
a second plurality of appointment data 302 of FIG. 3 may be the same as, similar to, and/or equivalent to the first plurality of appointment data 202 of FIG. 2;
a pre-scheduled appointment(s) 304 of FIG. 3 may be the same as, similar to, and/or equivalent to the pre-scheduled appointment(s) 206 of FIG. 2;
a predicted missed appointment(s) 306 of FIG. 3 may be the same as, similar to, and/or equivalent to the missed appointment(s) 210 of FIG. 2;
a predicted kept appointment(s) 308 of FIG. 3 may be the same as, similar to, and/or equivalent to the kept appointment(s) 212 of FIG. 2;
a predicted on-time appointment(s) 310 of FIG. 3 may be the same as, similar to, and/or equivalent to the on-time appointment(s) 214 of FIG. 2;
a predicted delayed appointment(s) 312 of FIG. 3 may be the same as, similar to, and/or equivalent to the delayed appointment(s) 216 of FIG. 2;
a predicted time-lead appointment(s) 314 of FIG. 3 may be the same as, similar to, and/or equivalent to the time-lead appointment(s) 218 of FIG. 2;
a predicted time-lag appointment(s) 316 of FIG. 3 may be the same as, similar to, and/or equivalent to the time-lag appointment(s) 220 of FIG. 2;
a predicted booking data 318 of FIG. 3 may be the same as, similar to, and/or equivalent to the booking data 222 of FIG. 2;
a predicted optimally-booked appointment(s) 320 of FIG. 3 may be the same as, similar to, and/or equivalent to the optimally-booked appointment(s) 224 of FIG. 2;
a predicted over-booked appointment(s) 322 of FIG. 3 may be the same as, similar to, and/or equivalent to the over-booked appointment(s) 226 of FIG. 2; and
a predicted under-booked appointment(s) 324 of FIG. 3 may be the same as, similar to, and/or equivalent to the under-booked appointment(s) 228 of FIG. 2.

For clarity, due to the unavailability of walk-in appointments in the future time period, FIG. 3 focuses on the data associated with pre-scheduled appointment(s) 304. Nevertheless, based on the walk-in appointment(s) 208 of FIG. 2 in the past time period, the first plurality of appointment data 202 of FIG. 2, and the second plurality of appointment data 302 of FIG. 3, the establishment 102 (e.g., the dealership) may predict with some accuracy the walk-in appointments and a total of predicted scheduled appointments in the future time period, where the predicted scheduled appointments (not illustrated) include the pre-scheduled appointment(s) 304 and the predicted walk-in appointments (not illustrated) in the future time period.

Unfortunately, similar to the past time period, the pre-scheduled appointment(s) 304 of FIG. 3 may include predicted missed appointment(s) 306 and/or predicted kept appointment(s) 308 in the future time period. For clarity, a count (or percentage) of the predicted missed appointment(s) 306 plus a count (or percentage) of the predicted kept appointment(s) 308 may equal the total count (or 100%) of the pre-scheduled appointment(s) 304 for the future time period.

In some embodiments, the predicted missed appointment(s) 306 may be appointments that some of the second plurality of persons may not keep at all in the future time period. For example, some of the second plurality of persons may desire to fix their respective vehicles at a dealership (e.g., the establishment 102) and may have scheduled to drop their respective vehicles at the dealership at certain times or at certain times for the future time period. However, based on the first plurality of appointment data 202 of FIG. 2 (historical data) and the second plurality of appointment data 302 of FIG. 3, some of the second plurality of persons are predicted to miss their respective appointments for the future time period.

Furthermore, even though some of the second plurality of persons may be predicted to keep their respective appointments, they may keep their respective appointments on a delayed time (e.g., predicted delayed appointment(s) 312 of FIG. 3). Therefore, in FIG. 3, the predicted kept appointment(s) 308 may include predicted on-time appointment(s) 310 and/or predicted delayed appointment(s) 312. For clarity, a count (or percentage) of the predicted on-time appointment(s) 310 plus a count (or percentage) of the predicted delayed appointment(s) 312 may equal the total count (or 100%) of the predicted kept appointment(s) 308.

In some embodiments, the establishment 102 (e.g., personnel working in, and/or associated with, the establishment 102) may define a predicted on-time appointment(s) 310 as a person arriving at the appointment within a predetermined time window of the pre-scheduled appointment(s) 304 in the future time period. The predetermined time window, however, may change depending on the type of the establishment. In some embodiments, the predetermined time window may only include a predetermined time period before the pre-scheduled appointment. For example, an airline may not accept passengers that arrive at a gate of an airport after the boarding of the plane has completed. In some embodiments, the predetermined time window may include a predetermined time period before the pre-scheduled appointment and a predetermined time period after the pre-scheduled appointment. For example, a dealership may consider a person arriving for a pre-scheduled appointment (e.g., the pre-scheduled appointment(s) 304 of FIG. 3) up to 15 minutes before the pre-scheduled appointment(s) 304, on time for the pre-scheduled appointment(s) 304, or up to 15 minutes later from the pre-scheduled appointment(s) 304, as being an on-time appointment (e.g., the predicted on-time appointment(s) 310).

In some embodiments, a predicted delayed appointment(s) 312 may be a predicted time-lead appointment(s) 314 or a predicted time-lag appointment(s) 316. In one aspect, the predicted time-lead appointment(s) 314 may be denoted as a positive predicted delayed appointment(s) 312, and the predicted time-lag appointment(s) 316 may be denoted as a negative predicted delayed appointment(s) 312. In another aspect, the predicted time-lead appointment(s) 314 may denote a person arriving before the pre-scheduled appointment(s) 304, and the predicted time-lag appointment(s) 316 may denote a person arriving after the pre-scheduled appointment(s) 304.

Since the walk-in appointments in the future time period are unknown, the establishment 102 can only predict the booking data for a time slot (illustrated as predicted booking data 318 of FIG. 3). The predicted booking data 318 may be an aggregate prediction (e.g., for the whole future time period), for a certain time period of the future time period (e.g., for the next day), for a time slot of the future time period (e.g., 10:30 AM of next day), and/or a combination thereof. Depending on the accuracy of the prediction, the predicted booking data 318 may show predicted optimally-booked appointment(s) 320, predicted over-booked appointment(s) 322, or predicted under-booked appointment(s) 324. The systems and methods described herein help the establishment 102 to have predicted optimally-booked appointment(s) 320.

In addition to, or alternatively of, what is explicitly illustrated in FIG. 3, the second plurality of appointment data 302 may include other data. For example, the second plurality of appointment data 302 may also include RO data that the dealership may have generated prior to the customer arriving at the dealership; geographic data of “sister” dealerships; a days-out value of the pre-scheduled appointment(s) 304; whether a person 104 opted to receive messages, reminders, and/or notifications from the dealership; the mileage of the vehicle; the year the vehicle was manufactured; whether the vehicle is under warranty; and/or other data that may correlate with any of the appointment categories illustrated in FIGS. 2 and 3.

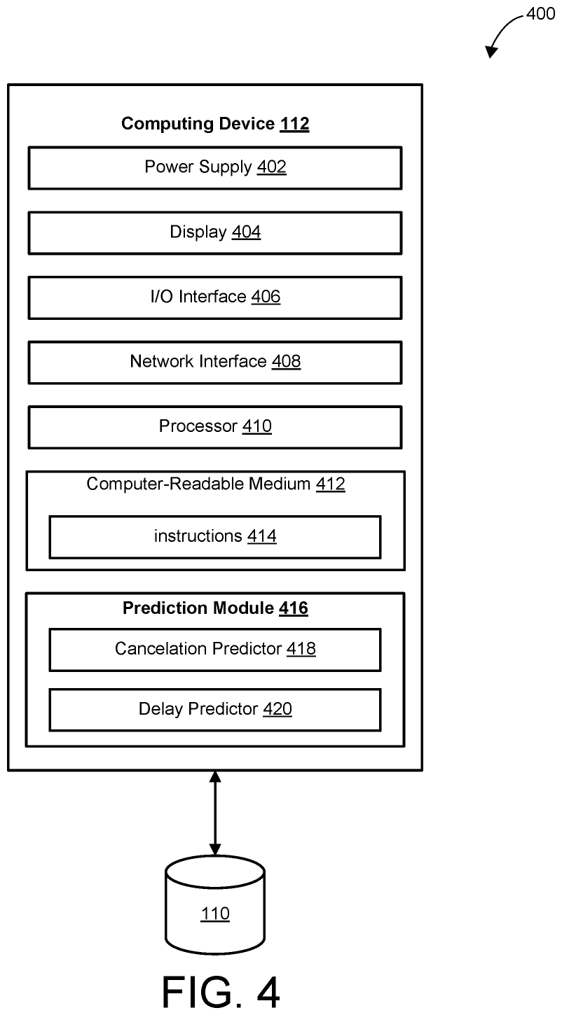

FIG. 4 illustrates an environment 400 of the computing device 112 accessing the first plurality of appointment data and the second plurality of appointment data stored in the database(s) 110 in accordance with examples described herein. For clarity, FIG. 4 is partly described in the context of FIGS. 1, 2, and 3. For example, the computing device 112 of FIG. 4 may be the same as the computing device 112 of FIG. 1. As another example, the database(s) 110 of FIG. 4 may be the same as the database(s) 110 of FIG. 1. As yet another example, the first plurality of appointment data and the second plurality of appointment data may be the same data described in FIG. 2 and FIG. 3, respectively.

In one embodiment, the computing device 112 may include a power supply 402, a display 404, an input/output (I/O) interface 406, a network interface 408, at least one processor 410, at least one computer-readable medium 412 with instructions 414, and a prediction module 416 with a cancelation predictor 418 and a delay predictor 420.

In some embodiments, the power supply 402 may provide power to various components within the computing device 112. Further, the power supply 402 may include one or more rechargeable, disposable, or hardwire sources, for example, a battery(ies), a power cord(s), an alternating current (AC) to direct current (DC) inverter (AC-to-DC inverter), a DC-to-DC converter, and/or the like. Additionally, the power supply 402 may include one or more types of connectors or components that provide different types of power (e.g., AC power, DC power) to any device that may be connected to the computing device 112. Additionally, or alternatively, the connector of the power supply 402 may also transmit data to and from any device connected to the computing device 112. For example, the connector of the power supply 402 may facilitate transmission of data to the database(s) 110, the user device 108 of the person 104, the establishment 102, the network 114, the base station(s) 116, the satellite(s) 118, and/or any other device that may be capable of receiving and/or transmitting data.

In some embodiments, the display 404 may be optional. However, if the computing device 112 includes and/or utilizes a display 404, the display 404 may display visual information, such as an image(s), a video(s), a graphical user interface (GUI), notifications, and so forth to a user (e.g., the personnel working in the establishment 102). The display 404 may utilize a variety of display technologies, such as a liquid-crystal display (LCD) technology, a light-emitting diode (LED) backlit LCD technology, a thin-film transistor (TFT) LCD technology, an LED display technology, an organic LED (OLED) display technology, an active-matrix OLED (AMOLED) display technology, a super AMOLED display technology, and so forth. Furthermore, the display 404 may be a touchscreen display that may utilize any type of touchscreen technology, such as a resistive touchscreen, a surface capacitive touchscreen, a projected capacitive touchscreen, a surface acoustic wave (SAW) touchscreen, an infrared (IR) touchscreen, and so forth. In such a case, the touchscreen may allow the personnel of the establishment 102 to interact with the computing device 112. For example, using a GUI displayed on the computing device 112, the personnel may select whether the person 104 arrived for the pre-scheduled appointment.

In some embodiments, the I/O interface 406 of the computing device 112 may enable the computing device 112 to receive an input(s) from the personnel of the establishment 102 and provide an output(s) to the personnel. In some embodiments, the I/O interface 406 may include, be integrated with, and/or may operate in concert and/or in situ with another component of any of the computing device 112, the establishment 102, the user device 108, the database(s) 110, the network 114, the base station(s) 116, the satellite(s) 118, and/or so forth.

In some embodiments, the network interface 408 illustrated in FIG. 4 may enable the computing device 112 to receive and/or transmit data directly to any of the network interfaces of any device or component illustrated and described in FIG. 1 and any other figure in this disclosure. Alternatively, or additionally, the computing device 112 may utilize the network interface 408 to communicate with other devices indirectly by, for example, using the network 114 of FIG. 1.

In some embodiments, the network interface 408 illustrated in FIG. 4 may include and/or utilize an application programming interface (API) that may interface and/or translate requests across the network 114 of FIG. 1, and the network interface 408 may support a wired and/or a wireless communication using any of the aforementioned communication protocols and/or standards.

In some embodiments, the processor 410 illustrated in FIG. 4 may be substantially any electronic device that may be capable of processing, receiving, and/or transmitting the instructions 414 that may be included in, permanently or temporarily saved on, and/or accessed by the computer-readable medium 412. In aspects, the processor 410 may be implemented using one or more processors (e.g., a central processing unit (CPU), a graphic processing unit (GPU)), and/or other circuitry, where the other circuitry may include as at least one or more of an application specific integrated circuit (ASIC), a field programmable gate array (ASIC), a microprocessor, a microcomputer, and/or the like. Furthermore, the processor 410 may be configured to execute the instructions 414 in parallel, locally, and/or across the network 114 of FIG. 1, for example, by using cloud and/or server computing resources.

In some embodiments, the computer-readable medium 412 illustrated in FIG. 4 may be and/or include any suitable data storage media, such as volatile memory and/or non-volatile memory. Examples of volatile memory may include a random-access memory (RAM), such as a static RAM (SRAM), a dynamic RAM (DRAM), or a combination thereof. Examples of non-volatile memory may include a read-only memory (ROM), a flash memory (e.g., NAND flash memory, NOR flash memory), a magnetic storage medium, an optical medium, a ferroelectric RAM (FeRAM), a resistive RAM (RRAM), and so forth. Moreover, the computer-readable medium 412 does not include transitory propagating signals or carrier waves.

In some embodiments, the instructions 414 that may be included in, permanently or temporarily saved on, and/or accessed by the computer-readable medium 412 of FIG. 4 may include code, pseudo-code, algorithms, models (e.g., machine-learned models), software modules and/or so forth and are executable by the processor 410.

In some embodiments, the computing device 112 can utilize the prediction module 416 to aid the establishment 102 to optimize appointment scheduling in the future time period. To do so, the prediction module 416 may include a cancelation predictor model 418 (cancelation predictor 418) and a delay predictor model 420 (delay predictor 420), as is further described herein. In aspects, the prediction module 416, the cancelation predictor 418, and the delay predictor 420 may be included in the instructions 414 illustrated in FIG. 4. Alternatively, or additionally, parts of or the entirety of any of the prediction module 416, the cancelation predictor 418, and/or the delay predictor 420 may be included in a server, a cloud, and/or any other device that may not be explicitly illustrated in FIGS. 1 to 4.

Aspects of certain embodiments described herein may be implemented as software modules or components. As used herein, a software module or component may include any type of computer instruction or computer-executable code located within or on a computer-readable storage medium, such as a non-transitory computer-readable medium. A software module may, for instance, comprise one or more physical or logical blocks of computer instructions, which may be organized as a routine, program, object, component, data structure, etc., that perform one or more tasks or implement particular data types, algorithms, and/or methods.

In some embodiments, any of instructions 414, the prediction module 416, the cancelation predictor 418, and/or the delay predictor 420 may include disparate code, pseudo-code, algorithms, machine-learned models, software modules, and/or so forth that may be stored in different locations of one or more computer-readable storage media, which together may implement the described functionality of the illustrated module(s) of FIG. 4. Some embodiments may be practiced in a distributed computing environment where tasks are performed by a remote processing device (not illustrated) linked through a communications network, such as the network 114. In a distributed computing environment, software modules may be located in local and/or remote computer-readable storage media. In addition, data being tied or rendered together in a database record may be resident in the same computer-readable storage medium, or across several computer-readable storage media, and may be linked together in fields of a record in a database (e.g., the database(s) 110) across a network (e.g., the network 114).

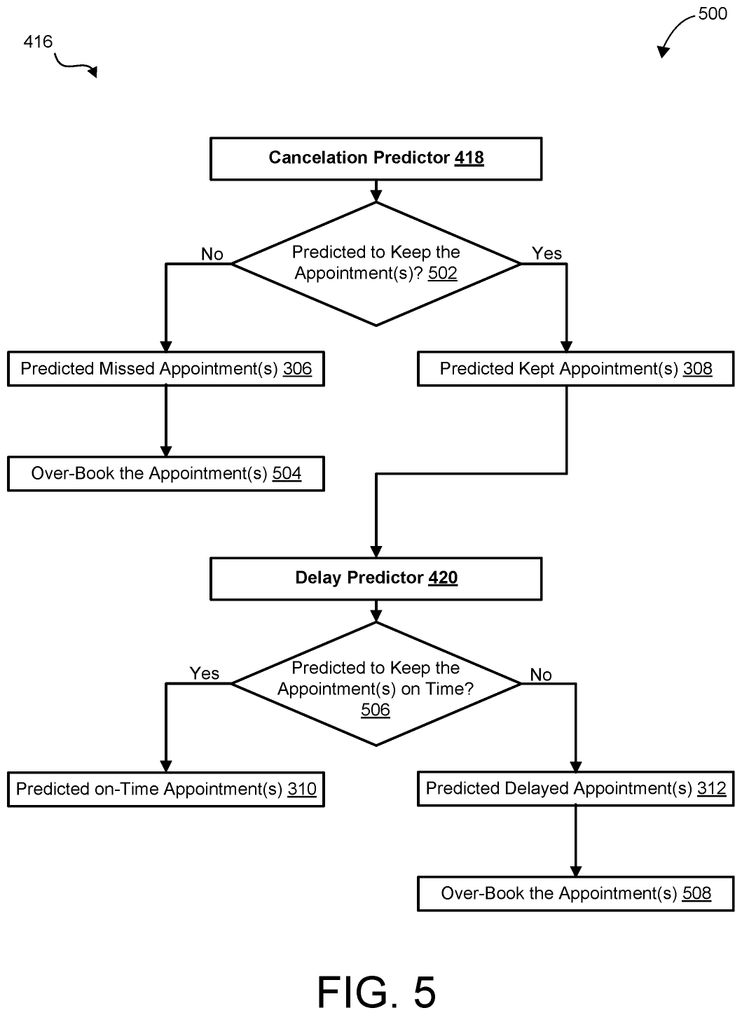

FIG. 5 illustrates an environment 500 using the prediction module 416 of FIG. 4 in accordance with examples described herein. FIG. 5 is illustrated and described in the context of FIGS. 1 to 4. As described and illustrated in FIGS. 1 and 4, the computing device 112 of FIGS. 1 and 4 accesses the first plurality of appointment data of the first plurality of persons and the second plurality of appointment data that may be stored in the database(s) 110 of FIG. 1. In some embodiments, the first plurality of appointment data are associated with a plurality of scheduled appointments (e.g., scheduled appointment(s) 204 of FIG. 2) over a past time period, and the second plurality of appointment data are associated with a plurality of pre-scheduled appointments (e.g., pre-scheduled appointment(s) 304 of FIG. 3) for a future time period.

As is illustrated in FIGS. 4 and 5, the prediction module 416 includes the cancelation predictor 418 and the delay predictor 420. In aspects, the prediction module 416 may be a two-tier prediction module and/or a chained ensemble architecture that performs a first predictive categorization and a second predictive categorization based on the first plurality of appointment data 202 of the past time period and the second plurality of appointment data 302 for the future time period. As is illustrated in FIGS. 4 and 5, a first tier (or a first part of the chained ensemble architecture) of the prediction module 416 includes the cancelation predictor 418, and a second tier (or a second part of the chained ensemble architecture) of the prediction module 416 includes the delay predictor 420.

As is described in FIG. 1, each of the persons 106 may use a myriad of methods and/or user devices (e.g., the user device 108) to pre-schedule their respective appointments for the future time period, such as the pre-scheduled appointment(s) 304 of FIG. 3. In some embodiments, the cancelation predictor 418 of the prediction module 416 helps determine a portion of the persons 106 that are predicted to keep the pre-scheduled appointment(s) 304 in the future time period (e.g., predicted kept appointment(s) 308) and another portion of the persons 106 that are predicted to miss the pre-scheduled appointment(s) 304 in the future time period (e.g., predicted missed appointment(s) 306). Therefore, in one aspect, the cancelation predictor 418 of the prediction module 416 may perform a predictive categorization that may be a binary categorization having two possible categories: a predicted missed appointment(s) 306 or a predicted kept appointment(s) 308. As such, the cancelation predictor 418 may enable the establishment 102 to automatically (or pseudo-automatically) perform a decision regarding the pre-scheduled appointment(s) 304, as is illustrated in FIG. 5 with decision block or rhombus labeled “predicted to keep the appointment(s)? 502.”

In some embodiments, the cancelation predictor 418 of the prediction module 416 aids and/or informs the establishment 102 regarding a percentage or count of the predicted missed appointment(s) 306 of the pre-scheduled appointment(s) 304. Furthermore, based on the second plurality of appointment data 302 for the future time period and/or historical data (e.g., the first plurality of appointment data 202 of the past time period), in addition to the prediction of the percentage or the count of the predicted missed appointment(s) 306, the cancelation predictor 418 may also offer insights as to which of the pre-scheduled appointment(s) 304 are most likely to be predicted missed appointment(s) 306 and which of the pre-scheduled appointment(s) 304 are most likely to be predicted kept appointment(s) 308.

In some embodiments, in FIG. 5, the blocks “cancelation predictor 418,” “predicted to keep the appointment(s)? 502,” and/or “predicted missed appointment(s) 306” can help the establishment 102 to over-book appointments to counterbalance (or cancel out) the predicted missed appointment(s) 306. Specifically, as is illustrated in FIG. 5, the establishment 102 can over-book the appointment(s) 504 for a specific time slot, a specific day, a specific week, and/or so forth for the future time period. Therefore, the establishment 102 does not have to rely on blind over-booking to increase their revenue, profits, operational efficiency, and so forth.

Unfortunately, the predicted kept appointment(s) 308 can also create operational inefficiencies if and/or when a portion of the predicted kept appointment(s) 308 are delayed appointments. To this end, the delay predictor 420 of the prediction module 416 may help predict a portion of the persons 106 that are predicted to be on time for the predicted kept appointment(s) 308 in the future time period (e.g., predicted on-time appointment(s) 310) and another portion of the persons 106 that are predicted to be delayed for the predicted kept appointment(s) 308 in the future time period (e.g., predicted delayed appointment(s) 312). Therefore, in one aspect, the delay predictor 420 may perform another predictive categorization that may be another binary categorization having two possible categories: a predicted on-time appointment(s) 310 or a predicted delayed appointment(s) 312. As such, the delay predictor 420 may enable the establishment 102 to automatically (or pseudo-automatically) perform another decision regarding the predicted kept appointment(s) 308, as is illustrated in FIG. 5 with a decision block or rhombus labeled “predicted to keep the appointment(s) on time? 506.”

In some embodiments, the delay predictor 420 of the prediction module 416 aids and/or informs the establishment 102 regarding a percentage or count of the predicted delayed appointment(s) 312 of the predicted kept appointment(s) 308. Furthermore, based on the second plurality of appointment data 302 for the future time period and/or historical data (e.g., the first plurality of appointment data 202 of the past time period), in addition to the prediction of the percentage or the count of the predicted delayed appointment(s) 312, the delay predictor 420 may also offer insights as to which of the predicted kept appointment(s) 308 are most likely to be predicted delayed appointment(s) 312 and which of the predicted kept appointment(s) 308 are most likely to be predicted on-time appointment(s) 310.

In some embodiments, in FIG. 5, the blocks “delay predictor 420,” “predicted to keep the appointment(s) on time? 506,” and/or “predicted delayed appointment(s) 312” can help the establishment 102 to over-book appointments to counterbalance (or cancel out) the predicted delayed appointment(s) 312. For example, even though an appointment(s) may be predicted to be a predicted kept appointment(s) 308, the appointment(s) may be predicted to be time-lag appointment(s) or time-lead appointment(s) for, for example, a specific time slot (e.g., 10:30 AM) for the future time period. In such a case the establishment 102 can over-book appointments for the specific time slot (e.g., 10:30 AM) for the future time period. Specifically, as is illustrated in FIG. 5, the establishment 102 can over-book the appointment(s) 508 for said specific time slot for the future time period. Therefore, the establishment 102 does not have to rely on blind over-booking for said specific time slot to increase their revenue, profits, operational efficiency, and so forth.

In some embodiments, the cancelation predictor 418 and/or the delay predictor 420 may utilize any binary classification (or categorization) algorithm. The binary classification algorithm of the cancelation predictor 418 may be the same algorithm as the delay predictor 420 or a different algorithm from the delay predictor 420. Also, each of the cancelation predictor 418 and the delay predictor 420 may use more than one algorithm to perform the respective binary classifications. The binary classification algorithms may be machine learning algorithms or supervised learning algorithms. Examples of the binary classification algorithm(s) are a Naive Bayes, a logistic regression, a k-nearest neighbors (k-NN), a support-vector machine (SVM), a decision tree, a bagging decision tree ensemble, a boosted decision tree ensemble (e.g., a gradient-boosted ensemble algorithm, a gradient boosting machine (GBM), a light gradient boosting machine (LightGBM or LGBM)), a random forest ensemble, a voting classification ensemble, a neural network, and/or any other binary classification algorithm.

In some embodiments, the cancelation predictor 418 and the delay predictor 420 may utilize an LightGBM or an LGBM classifier. The LGBM classifier may provide fast predictions (increased speed), may provide accurate predictions, may utilize fewer computing resources (e.g., the processor 410), and/or may use less memory (e.g., the computer-readable medium 412) compared to some of the other algorithms. Furthermore, the LGBM classifier may be free and open source.

In some embodiments, the LGBM classifier can be evaluated using metrics, such as a true positive (TP), a true negative (TN), a false positive (FP), and a false negative (FN). These metrics may help evaluate the output of the cancelation predictor 418 and/or the delay predictor 420 by, for example, using any of the calculations or Expressions 1 to 4.

$$Accuracy ( \frac{TP + TN}{TP + TN + FP + FN} ) \qquad Expression 1$$

$$Precision ( \frac{TP}{TP + FP} ) \qquad Expression 2$$

$$Recall ( \frac{TP}{TP + FP} ) \qquad Expression 3$$

$${Score}_{F 1} ( \frac{2 \cdot Recall \cdot Precision}{Recall + Precision} ) \qquad Expression 4$$

In some embodiments, Expression 1 may calculate a fraction, portion, and/or percentage of correct predictions; Expression 2 may calculate a fraction, portion, and/or percentage of correct positive identifications; Expression 3 may calculate a fraction, portion, and/or percentage of actual positives that are correctly identified; and Expression 4 may calculate a weighted average of Expression 2 and Expression 3.

In some embodiments, the dealership (e.g., the establishment 102 of FIG. 1) may utilize the two-tiered prediction module 416 to strategically connect and/or interact with the customers (e.g., persons 106 of FIG. 1). For example, after the cancelation predictor 418 identifies or predicts the predicted missed appointment(s) 306, personnel of the dealership may contact the portion of the customers that are most likely to miss their respective pre-scheduled appointments. The dealership may offer incentives to this portion of customers to keep their pre-scheduled appointments. The incentives may include a free service (e.g., free diagnostic services), a reduced price on a service, and/or other incentives. The dealership may also use this opportunity to connect with the customers in a more personal manner (e.g., a phone call) and build a rapport with the customers, and/or the dealership may simply confirm the predicted missed appointment(s) 306 and/or the predicted kept appointment(s) 308 before the pre-scheduled appointment(s) 304 in the future time period.

Additionally, or alternatively, the dealership (e.g., establishment 102) may use the appointment time slots from the predicted missed appointment(s) 306 to over-book (e.g., over-book the appointment(s) 504 of FIG. 5) the appointment time slots of the predicted missed appointment(s) 306. Similarly, the dealership may utilize the delay predictor 420 to determine appointment time slots of the predicted delayed appointment(s) 312, and the dealership may also over-book (e.g., over-book the appointment(s) 508 of FIG. 5) the appointment time slots of the predicted delayed appointment(s) 312.

Obviously, the dealership may prefer that most or all of the pre-scheduled appointment(s) 304 are predicted kept appointment(s) 308; moreover, the dealership may prefer that almost all or all of the predicted kept appointment(s) 308 are predicted on-time appointment(s) 310. Therefore, the dealership may provide an elevated experience to the customers with the predicted on-time appointment(s) 310 during and/or after the appointment. For example, personnel of the dealership may properly greet each customer of the predicted on-time appointment(s) 310, may offer the customer a beverage and/or a snack during the appointment, may take extra time to answer the questions of the customer, may valet the vehicle of the customer, may offer a ride to a destination of the customer's choosing while the vehicle of the customer is being serviced, may send an appreciation note to the address of the customer, may offer discounts for routine services, and/or other goods and/or services that show the dealership's appreciation for on-time appointments.

It is to be appreciated that the prediction module 416 with the cancelation predictor 418 and the delay predictor 420 helps the dealership to properly estimate the shop capacity, avoid collisions of customers' appointments, decrease the wait time in each appointment time slot, properly estimate a count of technicians or mechanics to service the vehicles, avoid a shortage of vehicle parts, decrease unnecessary inventory of vehicle parts, increase revenue, increase profits, increase customer satisfaction, increase personnel (or employee) job satisfaction, and the like. Furthermore, an improved vehicle-service business-side of the dealership may improve the vehicle-sales business-side of the dealership. For example, the dealership may properly estimate a count of salespersons, decrease unnecessary inventory of vehicles, avoid a shortage of vehicles, increase vehicle sales, further increase the revenue and profit of the dealership, and the like.

The disclosure includes additional example embodiments of the described methods and systems for optimizing appointment scheduling.

### Example Embodiments

Example 1. A computer-implemented method for aiding an establishment in scheduling future appointments, the computer-implemented method comprising: accessing a first plurality of appointment data of a first plurality of persons, the first plurality of appointment data being associated with a plurality of scheduled appointments over a past time period; accessing a second plurality of appointment data of a second plurality of persons, the second plurality of appointment data being associated with a plurality of pre-scheduled appointments for a future time period; based on the first plurality of appointment data and the second plurality of appointment data, performing a predictive categorization of the plurality of pre-scheduled appointments for the future time period, wherein: a first portion of the plurality of pre-scheduled appointments comprises a plurality of predicted kept appointments in the future time period; and a second portion of the plurality of pre-scheduled appointments comprise a plurality of predicted missed appointments in the future time period; and responsive to the predictive characterization of the plurality of pre-scheduled appointments, increasing an operational efficiency of the establishment in the future time period.

Example 2. The computer-implemented method of Example 1, wherein the predictive categorization of the plurality of pre-scheduled appointments comprises a first predictive categorization, and based on the first plurality of appointment data and the second plurality of appointment data, further performing a second predictive categorization of the plurality of pre-scheduled appointments for the future time period, wherein: a first portion of the plurality of predicted kept appointments comprises a plurality of predicted on-time appointments in the future time period; and a second portion of the predicted kept appointments comprises a plurality of predicted delayed appointments in the future time period; and responsive to the first and the second predictive categorizations, further increasing the operational efficiency of the establishment in the future time period.

Example 3. The computer-implemented method of Example 2, wherein: said performing of the first predictive categorization comprises performing a first binary categorization; and said performing of the second predictive categorization comprises performing a second binary categorization.

Example 4. The computer-implemented method of Example 2, wherein each predicted on-time appointment of the plurality of predicted on-time appointments comprises keeping a pre-scheduled appointment within a predetermined time frame of the pre-scheduled appointment, and the predetermined time frame is defined by the establishment.

Example 5. The computer-implemented method of Example 2, wherein each predicted delayed appointment of the plurality of predicted delayed appointments comprises keeping a pre-scheduled appointment outside a predetermined time frame of the pre-scheduled appointment.

Example 6. The computer-implemented method of Example 5, wherein: a first predicted delayed appointment of the plurality of predicted delayed appointments comprises a predicted time-lead appointment, wherein the predicted time-lead appointment comprises a first person predicted to arrive to the establishment before the pre-scheduled appointment in the future time period; and a second predicted delayed appointment of the plurality of predicted delayed appointments comprises a predicted time-lag appointment, wherein the predicted time-lag appointment comprises a second person predicted to arrive to the establishment after the pre-scheduled appointment in the future time period.

Example 7. The computer-implemented method of Example 1, wherein the first portion and the second portion of the plurality of pre-scheduled appointments comprise a total count of the plurality of pre-scheduled appointments.

Example 8. The computer-implemented method of Example 2, wherein the first portion and the second portion of the plurality of predicted kept appointments comprise a total count of the plurality of predicted kept appointments.

Example 9. The computer-implemented method of Example 1, wherein the first plurality of appointment data comprises a plurality of scheduled appointments, and the plurality of scheduled appointments comprises a plurality of pre-scheduled appointments, a plurality of walk-in appointments, or a combination thereof.

Example 10. The computer-implemented method of Example 2, wherein the establishment comprises a vehicle dealership, and the vehicle dealership utilizes the first and the second predictive categorizations to increase an operational efficiency of a vehicle-service business-side, a vehicle-sales business-side, or a combination thereof.

Example 11. The computer-implemented method of Example 2, wherein the establishment comprises a vehicle dealership, and wherein said establishment increasing the operational efficiency comprises estimating a shop capacity, avoiding collisions of pre-scheduled appointments, decreasing a wait time, estimating a count of technicians, decreasing a shortage of vehicle parts, decreasing an unnecessary inventory, increasing a revenue of the vehicle dealership, increasing a profit of the vehicle dealership, estimating a count of salespersons, or a combination thereof.

Example 12. The computer-implemented method of Example 11, wherein the first plurality of appointment data and the second plurality of appointment data further comprise a plurality of communication logs between the vehicle dealership and a plurality of customers of the vehicle dealership, warranty data of respective vehicles of the plurality of customers, mileage data of the respective vehicles of the plurality of customers, a manufacturing year of the respective vehicles of the customers, a days-out value of each pre-scheduled appointment of the plurality of pre-scheduled appointments, or a combination thereof.

Example 13. A system for scheduling appointments, the system comprises: a database, the database comprises: a first plurality of appointment data associated with a plurality of scheduled appointments over a past time period; and a second plurality of appointment data associated with a plurality of pre-scheduled appointments for a future time period; a computing device, the computing device comprises: a network interface; a processor; and a computer-readable medium storing instructions that, when executed by the processor, configure the computing device to: communicate with the database using the network interface; access a first plurality of appointment data and the second plurality of appointment data from the database; utilize a cancelation predictor to determine: a plurality of predicted kept appointments in the future time period, and a plurality of predicted missed appointments in the future time period; and utilize a delay predictor to determine: a plurality of predicted on-time appointments in the future time period, and a plurality of predicted delayed appointments in the future time period.

Example 14. The system of Example 13, wherein the first plurality of appointment data comprises a plurality of scheduled appointments, a plurality of pre-scheduled appointments, a plurality of missed appointments, a plurality of kept appointments, a plurality of on-time appointments, a plurality of delayed appointments, a plurality of predicted time-lead appointments, a plurality of time-lag appointments, a plurality of walk-in appointments, or a combination thereof during the past time period.

Example 15. The system of Example 13, wherein the second plurality of appointment data comprises a plurality of pre-scheduled appointments, the plurality of predicted missed appointments, the plurality of predicted kept appointments, the plurality of predicted on-time appointments, the plurality of predicted delayed appointments, a plurality of predicted time-lead appointments, a plurality of predicted time-lag appointments, or a combination thereof in the future time period.

Example 16. The system of Example 13, wherein the cancelation predictor and the delay predictor utilize a Naive Bayes algorithm, a logistic regression algorithm, a k-nearest neighbors (k-NN) algorithm, a support-vector machine (SVM), a decision tree algorithm, a bagging decision tree ensemble algorithm, a boosted decision tree ensemble algorithm, a GBM, an LGBM, a random forest ensemble algorithm, a voting classification ensemble algorithm, a neural network, or a combination thereof.

Example 17. A non-transitory computer-readable storage medium, the computer-readable storage medium including instructions that when executed by a processor, cause the processor to: access a first plurality of appointment data from a database, the first plurality of appointment data comprise a plurality of scheduled appointments over a past time period; access a second plurality of appointment data from the database, the second plurality of appointment comprise a plurality of pre-scheduled appointments for a future time period; based on the first plurality of appointment data and the second plurality of appointment data, perform a first predictive categorization of the plurality of pre-scheduled appointments for the future time period, wherein: a first portion of the plurality of pre-scheduled appointments comprise a plurality of predicted kept appointments in the future time period; and a second portion of the plurality of pre-scheduled appointments comprise a plurality of predicted missed appointments in the future time period; and responsive to the predictive characterization of the plurality of pre-scheduled appointments, increase an operational efficiency of the establishment in the future time period.

Example 18. The non-transitory computer-readable storage medium of Example 17, wherein the instructions when executed by the processor, further cause the processor to perform a second predictive categorization of the plurality of predicted kept appointments, wherein: a first portion of the plurality of predicted kept appointments comprises a plurality of predicted on-time appointments in the future time period; and a second portion of the predicted kept appointments comprises a plurality of predicted delayed appointments in the future time period; and responsive to the first and the second predictive categorizations, further increasing the operational efficiency of the establishment in the future time period.

Example 19. The non-transitory computer-readable storage medium of Example 18, wherein: the future time period comprises a next 24 hours, a next week, a next month, a next fiscal quarter, a next six months, a next year, or a next fiscal year; and the past time period comprises a previous 24 hours, a previous week, a previous month, a previous fiscal quarter, a previous six months, a previous year, or a previous fiscal year.

Example 20. The non-transitory computer-readable storage medium of Example 19, wherein each categorization of the first and the second predictive categorizations comprises an aggregate prediction for the future time period, a prediction for a time period within the future time period, a prediction for a time slot within the future time period, or a combination thereof.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention in this regard; no attempt is made to show structural details of the invention in more detail than is necessary for the fundamental understanding of the invention, the description taken with the drawings and/or examples making apparent to those skilled in the art how the several forms of the invention may be embodied in practice.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

Specific elements of any foregoing embodiments can be combined or substituted for elements in other embodiments. Moreover, the inclusion of specific elements in at least some of these embodiments may be optional, wherein further embodiments may include one or more embodiments that specifically exclude one or more of these specific elements. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

What is claimed is:

1. A computer-implemented method for aiding an establishment in scheduling future appointments, the computer-implemented method comprising:
accessing a first plurality of appointment data of a first plurality of persons, the first plurality of appointment data being associated with a plurality of scheduled appointments over a past time period;
accessing a second plurality of appointment data of a second plurality of persons, the second plurality of appointment data being associated with a plurality of pre-scheduled appointments for a future time period;
based on the first plurality of appointment data and the second plurality of appointment data, performing a predictive categorization of the plurality of pre-scheduled appointments for the future time period, wherein:
a first portion of the plurality of pre-scheduled appointments comprises a plurality of predicted kept appointments in the future time period; and
a second portion of the plurality of pre-scheduled appointments comprises a plurality of predicted missed appointments in the future time period; and
responsive to the predictive characterization of the plurality of pre-scheduled appointments, increasing an operational efficiency of the establishment in the future time period.

2. The computer-implemented method of claim 1, wherein the predictive categorization of the plurality of pre-scheduled appointments comprises a first predictive categorization, and based on the first plurality of appointment data and the second plurality of appointment data, further performing a second predictive categorization of the plurality of pre-scheduled appointments for the future time period, wherein:
a first portion of the plurality of predicted kept appointments comprises a plurality of predicted on-time appointments in the future time period; and
a second portion of the predicted kept appointments comprises a plurality of predicted delayed appointments in the future time period; and
responsive to the first and the second predictive categorizations, further increasing the operational efficiency of the establishment in the future time period.

3. The computer-implemented method of claim 2, wherein:
said performing of the first predictive categorization comprises performing a first binary categorization; and
said performing of the second predictive categorization comprises performing a second binary categorization.

4. The computer-implemented method of claim 2, wherein each predicted on-time appointment of the plurality of predicted on-time appointments comprises keeping a pre-scheduled appointment within a predetermined time frame of the pre-scheduled appointment, and the predetermined time frame is defined by the establishment.

5. The computer-implemented method of claim 2, wherein each predicted delayed appointment of the plurality of predicted delayed appointments comprises keeping a pre-scheduled appointment outside a predetermined time frame of the pre-scheduled appointment.

6. The computer-implemented method of claim 5, wherein:
a first predicted delayed appointment of the plurality of predicted delayed appointments comprises a predicted time-lead appointment, wherein the predicted time-lead appointment comprises a first person predicted to arrive to the establishment before the pre-scheduled appointment in the future time period; and
a second predicted delayed appointment of the plurality of predicted delayed appointments comprises a predicted time-lag appointment, wherein the predicted time-lag appointment comprises a second person predicted to arrive to the establishment after the pre-scheduled appointment in the future time period.

7. The computer-implemented method of claim 1, wherein the first portion and the second portion of the plurality of pre-scheduled appointments comprise a total count of the plurality of pre-scheduled appointments.

8. The computer-implemented method of claim 2, wherein the first portion and the second portion of the plurality of predicted kept appointments comprise a total count of the plurality of predicted kept appointments.

9. The computer-implemented method of claim 1, wherein the first plurality of appointment data comprises a plurality of scheduled appointments, and the plurality of scheduled appointments comprises a plurality of pre-scheduled appointments, a plurality of walk-in appointments, or a combination thereof.

10. The computer-implemented method of claim 2, wherein the establishment comprises a vehicle dealership, and the vehicle dealership utilizes the first and the second predictive categorizations to increase an operational efficiency of a vehicle-service business-side, a vehicle-sales business-side, or a combination thereof.

11. The computer-implemented method of claim 2, wherein the establishment comprises a vehicle dealership, and wherein said establishment increasing the operational efficiency comprises estimating a shop capacity, avoiding collisions of pre-scheduled appointments, decreasing a wait time, estimating a count of technicians, decreasing a shortage of vehicle parts, decreasing an unnecessary inventory, increasing a revenue of the vehicle dealership, increasing a profit of the vehicle dealership, estimating a count of salespersons, or a combination thereof.

12. The computer-implemented method of claim 11, wherein the first plurality of appointment data and the second plurality of appointment data further comprise a plurality of communication logs between the vehicle dealership and a plurality of customers of the vehicle dealership, warranty data of respective vehicles of the plurality of customers, mileage data of the respective vehicles of the plurality of customers, a manufacturing year of the respective vehicles of the customers, a days-out value of each pre-scheduled appointment of the plurality of pre-scheduled appointments, or a combination thereof.

13. A system for scheduling appointments, the system comprises:
a database, the database comprises:
a first plurality of appointment data associated with a plurality of scheduled appointments over a past time period; and
a second plurality of appointment data associated with a plurality of pre-scheduled appointments for a future time period;
a computing device, the computing device comprises:
a network interface;
a processor; and
a computer-readable medium storing instructions that, when executed by the processor, configure the computing device to:
communicate with the database using the network interface;
access a first plurality of appointment data and the second plurality of appointment data from the database;
utilize a cancelation predictor to determine:
a plurality of predicted kept appointments in the future time period; and
a plurality of predicted missed appointments in the future time period; and
utilize a delay predictor to determine:
a plurality of predicted on-time appointments in the future time period; and
a plurality of predicted delayed appointments in the future time period.

14. The system of claim 13, wherein the first plurality of appointment data comprises a plurality of scheduled appointments, a plurality of pre-scheduled appointments, a plurality of missed appointments, a plurality of kept appointments, a plurality of on-time appointments, a plurality of delayed appointments, a plurality of predicted time-lead appointments, a plurality of time-lag appointments, a plurality of walk-in appointments, or a combination thereof during the past time period.

15. The system of claim 13, wherein the second plurality of appointment data comprises a plurality of pre-scheduled appointments, the plurality of predicted missed appointments, the plurality of predicted kept appointments, the plurality of predicted on-time appointments, the plurality of predicted delayed appointments, a plurality of predicted time-lead appointments, a plurality of predicted time-lag appointments, or a combination thereof in the future time period.

16. The system of claim 13, wherein the cancelation predictor and the delay predictor utilize a Naive Bayes algorithm, a logistic regression algorithm, a k-nearest neighbors (k-NN) algorithm, a support-vector machine (SVM), a decision tree algorithm, a bagging decision tree ensemble algorithm, a boosted decision tree ensemble algorithm, a gradient boosting machine (GBM), a Light Gradient Boosting Machine (LGBM), a random forest ensemble algorithm, a voting classification ensemble algorithm, a neural network, or a combination thereof.

17. A non-transitory computer-readable storage medium, the computer-readable storage medium including instructions that when executed by a processor, cause the processor to:
access a first plurality of appointment data from a database, the first plurality of appointment data comprise a plurality of scheduled appointments over a past time period;
access a second plurality of appointment data from the database, the second plurality of appointment data comprise a plurality of pre-scheduled appointments for a future time period;
based on the first plurality of appointment data and the second plurality of appointment data, perform a first predictive categorization of the plurality of pre-scheduled appointments for the future time period, wherein:
a first portion of the plurality of pre-scheduled appointments comprises a plurality of predicted kept appointments in the future time period; and
a second portion of the plurality of pre-scheduled appointments comprises a plurality of predicted missed appointments in the future time period; and
responsive to the predictive characterization of the plurality of pre-scheduled appointments, increase an operational efficiency of the establishment in the future time period.

18. The non-transitory computer-readable storage medium of claim 17, wherein the instructions when executed by the processor, further cause the processor to perform a second predictive categorization of the plurality of predicted kept appointments, wherein:
a first portion of the plurality of predicted kept appointments comprises a plurality of predicted on-time appointments in the future time period; and
a second portion of the predicted kept appointments comprises a plurality of predicted delayed appointments in the future time period; and
responsive to the first and the second predictive categorizations, further increasing the operational efficiency of the establishment in the future time period.

19. The non-transitory computer-readable storage medium of claim 18, wherein:
the future time period comprises a next 24 hours, a next week, a next month, a next fiscal quarter, a next six months, a next year, or a next fiscal year; and
the past time period comprises a previous 24 hours, a previous week, a previous month, a previous fiscal quarter, a previous six months, a previous year, or a previous fiscal year.

20. The non-transitory computer-readable storage medium of claim 19, wherein each categorization of the first and the second predictive categorizations comprises an aggregate prediction for the future time period, a prediction for a time period within the future time period, a prediction for a time slot within the future time period, or a combination thereof.
